(19) United States
(12) Patent Application Publication
(10) Pub. No.: US 2020/0255656 A1
(43) Pub. Date: Aug. 13, 2020

(54) DEGRADATION-PROMOTED POLYMER AND METHOD FOR MAKING THEREOF

(71) Applicant: INNOVATIONS HOLDING CORPORATION, Eden Prairie, MN (US)

(72) Inventors: Kenneth W. RICHARDS, Plymouth, MN (US); Eric HALL, White Bear Lake, MN (US); Christopher E. RICHARDS, White Bear Lake, MN (US); Christopher J. CHAPMAN, Brooklyn Center, MN (US)

(21) Appl. No.: 16/639,408

(22) PCT Filed: Aug. 16, 2018
(86) PCT No.: PCT/US2018/046802

§ 371 Date: Feb. 14, 2020

Related U.S. Application Data
(60) Provisional application No. 62/546,389, filed on Aug. 16, 2017.

(51) Int. Cl. C08L 67/04; B29C 48/03

(52) U.S. Cl. CPC C08L 67/04; C09K 8/68; B29C 48/03

(57) ABSTRACT

Provided herein include a degradation-promoted polymer and a method for making the degradation-promoted polymer. The degradation-promoted polymer has a composition containing one or more polymers and a degradation-promoting agent that includes Lactide and an organic acid. The organic acid may include at least one of succinic acid, levulinic acid, and lauric acid. The degradation-promoting agent can promote and control the degradation of the polymer in aqueous-based environments having different temperatures, pressures depths, and aqueous solutions. The method includes mixing a polymer with a degradation-promoting agent to produce a degradation-promoted polymer. Application for such degradation-promoted polymer can include but not limited to such as for example a process for opening new oil well, oil well work-over, or oil well cleanout, in which each well may have a different temperature and may require a different degradation rate of the polymer.

### FIELD

Embodiments disclosed herein relate generally to a degradable polymer. Specifically, the embodiments disclosed herein relate to a degradation-promoted polymer and a method for making said degradation-promoted polymer.

### BACKGROUND

Hydraulic fracturing or fracking has been used for the past 60 years to improve oil extraction from a drilled well. Sand, gels, additives, and, most recently, polymers have been added to the fracking process. Oil wells are drilled at various depths, to which the varying depths may affect the temperature down hole in the fracking zone. The temperatures of shallow to deep wells may range from 90° F. to 210° F. As part of the fracking process a material, known as divert, is pumped down the well hole to fill holes made in the pipe at the fracking zone. The divert is used to plugs the holes. This plugging is used to reduce the flow of fluid into the frack zone to allow the oil to begin free flow in the fractures created by the fracking process.

### SUMMARY

Embodiments disclosed herein relate generally to a degradable polymer. Specifically, the embodiments disclosed herein relate to a degradation-promoted polymer and a method for making said degradation-promoted polymer.

The embodiments described herein allow for the judicious utilization of various inputs for making and engineering degradation-promoted polymers so that the degradation-promoted polymers can be degraded at a desired rate in a given environmental condition.

In some embodiments, a degradation-promoted polymer includes a degradable polymer and a degradation-promoting agent.

In some embodiments, the degradation-promoting agent can include an organic acid and a Lactide. In some embodiments, the organic acid is an acid having a pH value lower than 3.0 at 100 mM concentration and 23° C. In some embodiments, the organic acid is an acid having a pH value lower than 2.5 at 100 mM concentration and 23° C. In some embodiments, the organic acid is an acid having a pH value lower than 2.0 at 100 mM concentration and 23° C. In some embodiments, the organic acid is or includes succinic acid (SA). In some embodiments, the organic acid is or includes levulinic acid. In some embodiments, the organic acid is or includes lauric acid. In some embodiments, the organic acid includes two or more of SA, levulinic acid, and lauric acid.

In some embodiments, the polymer can have a composition including two or more different degradable polymers. In some embodiments, the two or more polymers can have different glass transition temperature (Tg). In some embodiments, the two or more polymers combined have a Tg greater than 27° C. In some embodiments, the two or more polymers have a Tg greater than 40° C. The polymer can include Polyhydroxyalkanoic acid (PHA) or Polylactic acid (PLA). In some embodiments, the two or more polymers can be different types of Polylactic acids (PLAs). In some embodiments, the two or more polymers can have a crystalline, semi-crystallize, or amorphous form.

In some embodiments, the degradation-promoted polymer has a Tg greater than 27° C. In some embodiments, the degradation-promoted polymer has a Tg greater than 40° C.

In some embodiments, a method for making the degradation-promoted polymer that includes a degradable polymer and a degradation-promoting agent is provided. In some embodiments, the method can include mixing a degradable polymer with a degradation-promoting agent to produce a degradation-promoted polymer. In one embodiment, the method can include mixing a degradable polymer with a degradation-promoting agent that includes an organic acid and a Lactide. In some embodiment, the step of mixing a degradable polymer with a degradation-promoting agent can include blending two or more polymers. In some embodiments, the step of mixing a polymer with a degradation-promoting agent can include blending a PHA, or Polybutylene Succinate (PBS). In some embodiment, the step of mixing a polymer with a degradation-promoting agent can include compounding a polymer with an acid (e.g., succinic, levulinic, or lauric acid) and Lactide.

In some embodiments, the method can further include blending a compatibilized filler with the degradation-promoted polymer to produce a degradation-promoted polymer composite.

In some embodiments, the method can further include blending a second compatibilized filler with the degradation-promoted polymer composite to produce a degradation-promoted polymer composite polymer.

In some embodiments, the method further includes venting and evacuating the degradation-promoted polymer composite or the degradation-promoted polymer composite polymer to remove residual water.

In some embodiments, the method further includes extruding a degradation-promoted polymer composite or a degradation-promoted polymer deposit to form a predetermined shape.

### BRIEF DESCRIPTION OF DRAWINGS

References are made to the accompanying drawings that form a part of this disclosure, and which illustrate embodiments in which products and methods described in this specification can be practiced.

FIG. 1 is a graph illustrating dissolution of Lactide at 120° F. as a function of time in an aqueous solution, according to an embodiment.

FIG. 2 is a graph illustrating dissolution of Lactide at 140° F. as a function of time in an aqueous solution, according to an embodiment

FIG. 3 is a graph illustrating degradation of NatureWorks® 4060D PLA as a function of time in water at 88° C. and in the absence of a degradation-promoting agent, according to an embodiment.

FIG. 4 is a graph illustrating degradation of NatureWorks® 6362D PLA as a function of time in water at 88° C. and in the absence of a degradation-promoting agent, according to an embodiment.

FIG. 5 is a graph illustrating degradation of NatureWorks® 6362D PLA at the presence of 16.5 percent Lactide as a degradation-promoting agent at different temperatures, according to an embodiment.

FIG. 6 is a graph illustrating degradation of a degradation-promoted polymer that has a composition of 83.5% NatureWorks® 6362D PLA, 8.25% Lactide, and 8.25% succinic acid at temperatures of 49° C., 60° C., and 88° C., according to an embodiment.

FIG. 7 is a graph illustrating degradation of a degradation-promoted polymer that has a composition of 72% NatureWorks® 6362D PLA, 14% Lactide, and 14% succinic acid at temperatures of 49° C., 60° C., and 88° C., according to an embodiment.

FIG. 8 is a graph illustrating degradation of a degradation-promoted polymer that has a composition of 64% NatureWorks® 6362D PLA, 24% Lactide and 12% succinic acid at temperatures of 49° C., 60° C., and 88° C., according to an embodiment.

FIG. 9 is a graph illustrating degradation of a degradation-promoted polymer that has a composition of 64% NatureWorks® 6362D PLA, 18% Lactide and 18% succinic acid at temperatures of 49° C., 60° C., and 88° C., according to an embodiment.

FIG. 10 is a graph illustrating degradation of a degradation-promoted polymer that has a composition of 66% NatureWorks® 6362D PLA, 22% Lactide, and 22% succinic acid at temperatures of 49° C., 60° C., and 88° C., according to an embodiment.

FIG. 11 is a graph illustrating degradation of a degradation-promoted polymer that has a composition of 28% NatureWorks® 6362D PLA, 28% NatureWorks® 4046D PLA, 14% succinic acid at temperatures of 49° C., 69° C., and 88° C., according to an embodiment.

FIG. 12 is a graph illustrating degradation of a degradation-promoted polymer that has a composition of 28% NatureWorks® 6362D PLA, 28% NatureWorks® 4046D PLA, 24% succinic acid, and 24% Lactide at temperatures of 49° C., 69° C., and 88° C., according to an embodiment.

FIG. 13 is a graph illustrating degradation of a degradation-promoted polymer that has a composition of 28% NatureWorks® 6362D PLA, 28% NatureWorks® 4046D PLA, 22% succinic acid, and 22% Lactide at temperatures of 49° C., 60° C., and 71° C. over about 30 day period, according to an embodiment.

FIG. 14 is a graph illustrating degradation of a degradation-promoted polymer that has a composition of 86% PBS and 14% succinic acid at temperatures of 48° C., 60° C., and 88° C., according to an embodiment.

FIG. 15 is a graph illustrating degradation of a degradation-promoted polymer that has a composition of 28% NatureWorks® 6362D PLA, 86% PBS, and 14% succinic acid at temperatures of 48° C., 60° C., and 88° C., according to an embodiment.

### DETAILED DESCRIPTION

In the following detailed description, reference is made to the accompanying drawings and experimental data, which form a part hereof, and in which are shown, by way of illustration, specific embodiments in which the methods described herein may be practiced. These embodiments are described in sufficient detail to enable those skilled in the art to practice the described methods, and it is to be understood that the embodiments may be combined or used separately, or that other embodiments may be used, and that design, implementation, and procedural changes may be made without departing from the spirit and scope of the methods described herein. The following detailed description provides examples and data resulting from experiments performed.

Embodiments disclosed herein relate generally to a degradable polymer. Specifically, embodiments disclosed herein relate to a degradation-promoted polymer and a method for making this degradation-promoted polymer.

The degradation-promoted polymer can have a composition containing a polymer and a degradation-promoting agent.

The term “polymer” as used herein is defined as any macromolecule or system of macromolecules commonly referred to as “polymeric,” and includes without limitation naturally occurring and synthetically-produced macromolecules, repeating and non-repeating chain macromolecules, and degradable biopolymer and biopolymers.

The terms “degradation-promoted polymer” are interchangeably with “promoted polymer” and are defined as a degradable polymer, or a blend of more than one degradable polymer, that has been blended with at least one degradation-promoting agent for purpose of controlling and accelerating the degradation of the polymer in accordance with its application requirements and environmental conditions.

The term “degradable biopolymer”, “biopolymer”, and “polymer” may be a polymeric material defined as one or more polymer(s) or other materials including or containing polymer(s), including but not limited to blends of polymers, co-polymers, hybrid materials including bonded polymers and non-polymeric materials, and/or composites of or including any of the foregoing.

The terms “degradation-promoting agent” may be used interchangeably with “promoting agent” and refer to an agent that is blended with a polymer such that, when the polymer is subjected to appropriate environmental conditions, the degradation-promoting agent can accelerate the degradation of the polymer (as compared to the degradation rate of the polymer in the absence of the degradation-promoting agent) at a rate required for the specific application and environmental conditions. Specifically, these embodiments have been engineered for oil well applications where wells temperatures and other environmental characteristics will vary and may require different degradation rates. However, these same embodiments are not limited to this application alone.

In an embodiment, the degradation is a hydrolysis process. The term “hydrolysis-promoted polymer” is referred to a degradation-promoted polymer that is degraded via a hydrolysis process. The term “hydrolysis-promoted biopolymer” is referred to a degradation-promoted polymer which contains biopolymer and which is degraded via a hydrolysis process. When a hydrolysis-promoted polymer exposed to fracking environment, the rate of degradation of the hydrolysis-promoted polymer is enhanced compared to the degradation of the raw polymer(s) that does not incorporate the degradation-promoting agents and other inputs.

The term “input” or “inputs” as used herein is defined as any input material, chemical, compound, blend, composite or substance that is an additive or component utilized to produce a degradation-promoted polymer. The input or inputs may include at least one degradable biopolymer and at least one degradation-promoting agent, as well as one or more additives, a caustic moiety, fillers, and processing aids.

In an embodiment, the polymer is a degradable polymer. In an embodiment, the polymer is a degradable biopolymer. Degradable biopolymers can include but not limited to, for example, Polylactic acid (PLA), Polyhydroxyalkanoic acid (PHA), Polyhydroxybutyrate (PHB), Poly Glycolic acid (PGA), etc., and other polyesters including such as, for example, Polybutylene Succinate (PBS), etc.

The term “Polyhydroxyalkanoic Acid” refers to a class of polymers that is herein represented by the acronym PHA and is used interchangeably within this disclosure. Polylactic Acid and Polyglycolic Acid are examples of PHAs. Additional examples of PHAs include Polyhydroxybutyrate, Polyhydroxyvalerate and Polyhydroxyhexanoate and their copolymers, such as, for example, Poly(lactic-co-glycolic acid), Poly(hydroxybutyrate-co-hydroxyvalerate), etc. PHAs have the general structure of:

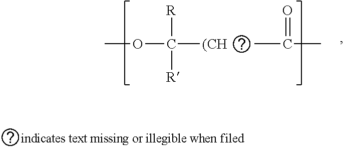

where n is greater than or equal to zero and where R or R′ can be either hydrogen or alkyl groups such as methyl, ethyl, etc.

The polymer can be in crystalline, semi-crystallize, or amorphous forms. In an embodiment, the polymer is in crystalline form. In an embodiment, the polymer is in semi-crystalline form. In an embodiment, the polymer is in amorphous form.

In an embodiment, the polymer has a composition that includes one or more polymers. The polymers can be synthetic, natural, or composite polymers. In an embodiment, the polymer can have a composition that includes one or more biopolymers. In an embodiment, the polymer can have a composition that includes both a biopolymer and a synthetic polymer. The polymer can be degradable.

In an embodiment, a degradable biopolymer is composed of at least 2 ester-based polymers and one or more degradation-promoting agents are added such as an acid (e.g., succinic acid, levulinic acid, lauric acid, etc.) from about 5 percent to about 25 percent by weight of the weight of the degradation-promoted polymer and Lactide from about 5 percent to about 25 percent of the weight of the degradation-promoted polymer.

In an embodiment, a degradable biopolymer is composed of a PLA and one or more degradation-promoting agents are added such as an acid (e.g., succinic acid, levulinic acid, lauric acid, etc.) from about 5 percent to about 25 percent by weight of the weight of the degradation-promoted polymer and Lactide from about 5 percent to about 25 percent of the weight of the degradation-promoted polymer.

In an embodiment, a degradable biopolymer is composed of at least 2 different grades of PLA having different molecular weights and/or degrees of crystallinity and one or more degradation-promoting agents. The one or more degradation-promoting agents such as an acid (e.g., succinic acid, levulinic acid, lauric acid, etc.) account for about 5 percent to about 25 percent by weight of the weight of the degradation-promoted polymer and Lactide from about 5 percent to about 25 percent of the weight of the degradation-promoted polymer.

In an embodiment, a degradable biopolymer may be modified or compatibilized, for example, by blending and/or combining them with other degradable biopolymers, fillers or additives, for purposes of meeting processing needs and the physical and/or degradation requirements of the intended application or applicable environmental conditions. The fillers may be organic fillers that may be dissolved in an aqueous environment. The organic fillers include carbohydrates such as for example sugar and starch.

In an embodiment, at least one organic filler, for example starch or a sugar, may be added to a degradable biopolymer for example PLA from 5 to about 25 percent the weight of the degradation-promoted polymer.

The degradation-promoting agent can include but not limited inorganic acid, organic acid, small molecular ester including Lactide, etc. In an embodiment, degradation-promoting agent can include an organic acid. In an embodiment, degradation-promoting agent can include an organic acid and Lactide. In an embodiment, degradation-promoting agent can include succinic acid and Lactide. In some embodiments, the succinic acid can be replaced with levulinic acid and/or lauric acid.

In an embodiment, a degradation-promoting agent includes an acid. In an embodiment, the acid is an organic acid. In an embodiment, the organic acid is a bio acid. In an embodiment, the organic acid has a pH value lower than 3.0 at 100 mM concentration and 23° C. In an embodiment, the organic acid has a pH value lower than 2.5 at 100 mM concentration and 23° C. In an embodiment, the organic acid is an acid has a pH value lower than 2.0 at 100 mM concentration and 23° C. In an embodiment, a degradation-promoting agent is succinic acid. In some embodiments, the succinic acid can be replaced with levulinic acid and/or lauric acid.

In an embodiment, the organic acid has a pH value 5.0-1.0 at 100 mM concentration and 23° C. In an embodiment, the organic acid has a pH value 3.0-1.0 at 100 mM concentration and 23° C. In an embodiment, the organic acid has a pH value 2.0-1.0 at 100 mM concentration and 23° C. In an embodiment, a degradation-promoting agent for promoting degradation of degradable biopolymers such as, for example, PHA, PLA, PBS, PGA, PHB and other degradable ester polymers, may include one or more organic acids. In some embodiments, the one or more organic acids can include a low molecular weight organic acid. The organic acids can include, for example, formic acid, acetic acid, oxalic acid, succinic acid, levulinic acid, lauric acid etc. In an embodiment, the organic acid is or includes SA. In an embodiment, the organic acid is or includes levulinic acid. In an embodiment, the organic acid is or includes lauric acid. In an embodiment, the organic acid includes two or more of SA, levulinic acid, and lauric acid.

The term “ester polymers” as used herein is defined as polymers that contain an ester linkage in the backbone of the polymer. Ester polymers include, for example, PHAs such as PLA, PGA, etc., Polycaprolactone (PCL), and polymers formed by the copolymerization of a diol and a diacid, such as, for example, Polybutylene Succinate (PBS), etc.

In an embodiment, the degradation-promoting agent is a small ester molecule including Lactide. In an embodiment, a degradation-promoting agent for promoting degradation of PLA may include Lactide from 5% to 25% by weight of the degradation-promoted polymer. In an embodiment, the degradation-promoting agent for promoting degradation of PLA may include Lactide from about 5% to about 18% by weight of the degradation-promoted polymer. In an embodiment, the degradation-promoting agent for promoting degradation of PLA may include an organic acid such as succinic acid from about 5% to about 18% by weight of the degradation-promoted polymer. In an embodiment, the degradation-promoting agent for promoting degradation of PLA may also include one or more organic fillers such as for example starch or sugar from about 4% to about 20% by weight of the degradation-promoted polymer. In some embodiments, the succinic acid can be replaced with levulinic acid and/or lauric acid.

In an embodiment, a degradation-promoting agent for promoting degradation of PBS may include an organic acid such as succinic acid added for example from about 5% to about 25% by weight of the degradation-promoted polymer. In some embodiments, the succinic acid can be replaced with levulinic acid and/or lauric acid.

In an embodiment, a degradation-promoting agent for promoting degradation of PBS may include an organic acid such as succinic acid from about 5% to about 25% by weight of the degradation-promoted polymer. In an embodiment, a degradation-promoting agent for promoting degradation of PBS may also include organic filler such as for example starch or sugar from about 4% to about 20% by weight of the degradation-promoted polymer. In some embodiments, the succinic acid can be replaced with levulinic acid and/or lauric acid.

In an embodiment, the degradation-promoted polymer may be a blend of more than one biopolymer such as PLA and PBS, in which the PLA may be from about 15% to about 95% by weight of the biopolymer blend and the PBS may be from about 5% to about 85% by weight of the biopolymer blend.

In an embodiment, a degradation-promoting agent for promoting degradation of PLA and PBS blend may include Lactide from about 5% to about 25% by weight of the degradation-promoted polymer and an organic acid such as succinic acid from about 5% to about 25% by weight of the degradation-promoted polymer. In some embodiments, the succinic acid can be replaced with levulinic acid and/or lauric acid.

In an embodiment, a degradation-promoting agent for promoting degradation of PLA and

PBS blend may include Lactide from about 5% to about 25% the weight of the degradation-promoted polymer. In an embodiment, the degradation-promoting agent for promoting degradation of PLA and PBS blend may include an organic acid such as succinic acid from about 5% to about 25% the weight of the degradation-promoted polymer. In an embodiment, the degradation-promoting agent for promoting degradation of PLA and PBS blend may also include organic filler such as starch or sugar from about 4% to about 20% the weight of the degradation-promoted polymer. In some embodiments, the succinic acid can be replaced with levulinic acid and/or lauric acid.

The degradation-promoting agent can promote and control the degradation of the polymer. In an embodiment, the degradation-promoting agent can promote and control the degradation of the polymer in aqueous-based environments, which can have different environmental parameters including but not limited to for example temperatures, pressures depths, and/or aqueous solutions.

In an embodiment, a degradation-promoting agent can be mixed with a blend of two or more degradable biopolymers that have been blended for specific physical properties. The blends can include, for example, a Polylactic Acid and Polybutylene Succinate (PBS), Polyglycolic Acid blend, a Polylactic Acid and Polyhydroxybutyrate blend, blends of Polylactic Acid polymers having differing molecular weights or degrees of crystallinity.

In an embodiment, a degradation-promoting agent may be an acidic moiety compounded or incorporated into a degradable biopolymer such as, for example, polymers including ester bonds such as, for example, a PHA or other ester polymers, which acidic moiety can promote the rate of degradation through hydrolysis by an acid-catalyzed attack of an ester bond of the degradable bio-polymer in environmental conditions where there is direct contact with a aqueous based, or moist environment, and environmental temperature ranges from about 32° C. to about 160° C. In an embodiment, a degradation-promoting agent for promoting degradation of PLA may include an acidic moiety such as succinic acid added for example from 5 to about 25 percent the weight of the degradation-promoted polymer. In some embodiments, the succinic acid can be replaced with levulinic acid and/or lauric acid.

In an embodiment, a degradable biopolymer is compounded with an appropriate amount and type of degradation-promoting agent, for example, an acidic moiety, to obtain a degradation-promoted polymer that will degrade according to the application requirements.

In an embodiment, a degradable biopolymer and a degradation-promoting agent such as, for example, an acidic moiety for degradation-promotion can be compounded where the acidic moiety added may be for example from about 5% to about 25% by weight of the weight of the degradation-promoted polymer.

In an embodiment, when using an acidic moiety such as, for example, succinic acid, as the degradation-promoting agent a degradation-promoting mechanism of the input polymer can include an initial attack of hydrogen ion on a carbonyl followed by a subsequent proton transfer cleavage of the ester bond and liberation of the alcohol and acid in a water rich environment. For example, degradation can proceed through ester hydrolysis. Examples of acid moieties that can act as degradation-promoting agents can include, for example, one or more organic acids. In some embodiments, the one or more organic acids is a low molecular weight organic acid. In some embodiments, the organic acid can be, for example, formic, acetic, adipic, oxalic, succinic, levulinic, lauric acid, etc.

A method for making a degradation-promoted polymer product can include mixing a polymer with a degradation-promoting agent to produce a degradation-promoted polymer. In an embodiment, the method for making a degradation-promoted polymer product can include a step of blending a compatibilized filler with the degradation-promoted polymer to produce a degradation-promoted polymer composite. In an embodiment, the method for making a degradation-promoted polymer product can include a step of venting and evacuating the degradation-promoted polymer composite to remove residual water. In an embodiment, the method for making a degradation-promoted polymer product can include a step of blending the degradation-promoted polymer composite with a second filler to produce a degradation-promoted composite polymer. In an embodiment, the method for making a degradation-promoted polymer product can further include extruding the degradation-promoted polymer composite or the degradation-promoted polymer composite polymer to form a predetermined shape. Degradation-promoted polymers may be produced in various forms: for example, they may be produced in various forms factors, for example pellets, powder, or flakes that may be used in this form in the application individually or mixed or utilized as an intermediates. The intermediate form (pellet, powder, flake) of the degradation-promoted polymer may be utilized by various other methods of molding, forming or processing (e.g., thermoforming, blow-molding, extrusion or injection molding, etc.) to produce end-use products such as, for example, injection molded articles, sheets, films or extruded articles.

In some embodiments, the glass transition temperature (Tg) of the degradation-promoted polymer is greater than 27° C. In some embodiments, the Tg of the degradation-promoted polymer is greater than 40° C. The addition of a degradation-promoting agent such as Lactide and Succinic acid to the polymer can decrease the Tg of the resulting degradation-promoted polymer. When the Tg of the degradation-promoted polymer is about 27° C. or lower, the degradation-promoted polymer can be so soft that it may compact under its own weight and eventually becomes a brick, and thus resulting in a degradation-promoted polymer that may not be functional for its intended application. Transportation can also be an issue for a degradation-promoted polymer having a low Tg that is, for example, less than or equal to 27° C., as the degradation-promoted polymer may not hold its shape but may compact and become a brick. In an embodiment, the step of mixing a polymer with a degradation-promoting agent can include blending two or more polymers. In an embodiment, the two or more polymers are different type of PLA having different glass transition temperature (Tg). In one embodiment, each of the two or more polymers has a Tg greater than 27° C. In an embodiment, one of the two or more polymers can have a Tg greater than 32° C. In an embodiment, one of the two or more polymers can have a Tg greater than 38° C. In an embodiment, one of the two or more polymers can have a Tg greater than 45° C. In an embodiment, one of the two or more polymers has a Tg of greather than 50° C. In an embodiment, one of the two or more polymers can have a Tg of about 55-56° C. In an embodiment, one of the two or more polymers has a Tg of about 60° C. In an embodiment, one of the two or more polymers has a Tg of about 50° C. In an embodiment, one of the two or more polymers has a Tg of about 40° C. In an embodiment, one of the two or more polymers has a Tg of about 30° C. In an embodiment, the two or more polymers are in crystalline, semi-crystallize, or amorphous forms.

In an embodiment, the step of mixing a polymer with a degradation-promoting agent can include blending a PHA or PBS. In an embodiment, the step of mixing a polymer with a degradation-promoting agent can include compounding the polymer with an acid (e.g., a succinic acid, a levulinic acid, a lauric acid, etc.).

Embodiments are also provided for engineering a degradation-promoted polymer by the judicious choice of types and amounts of inputs (e.g., specific degradable bio-polymers, degradation-promoting agents, fillers and/or other additives) that can influence the degradation rate without degrading the physical or other properties of the resulting material and that meet the environmental, degradation and other requirements or conditions of the application. Furthermore, the appropriate manner, sequence, steps and control of the compounding process of the degradable biopolymer with the degradation-promoting agent can be managed to achieve, among other things, an even distribution and disbursement of the degradation-promoting agent, resulting in its intimate contact throughout the polymeric matrix for better control and predictable degradation of the polymer under specified environmental conditions.

The terms “engineer” or “engineering” as used herein refer to the making of degradation-promoted polymer(s) through the judicious choice of inputs (such as degradable biopolymers, degradation-promoting agents, fillers, and other additives or components) to achieve physical and degradation characteristics of the degradation-promoted polymer in accordance with application requirements and environmental conditions.

The methods described herein relate to promoting and controlling degradation of a polymer by incorporating, mixing, processing, blending, and/or compounding one or more degradation-promoting agents and other additives with and into a polymer to control degradation of the polymer at a desired rate in accordance with environmental conditions. The environmental conditions include but not limited to temperature and pressure. The term “mix” or “mixing” herein can include blending and compounding. In an embodiment of a compounding process, a degradable biopolymer can be modified by saponification such as, for example, through the addition of a caustic. The modified polymer can be de-volatized. The de-volatized polymer can be blended with a degradation-promoting agent such as, for example, an acid moiety. The blended mixture can be evacuated to remove any residual water, prior to extrusion and pelletization.

A degradable biopolymer may be, for example, Polylactic acid (PLA), which may include PLAs of different molecular weights and degrees of crystallinity. The PLAs can be saponified, modified to achieve a different average molecular weight by addition of a caustic such as, for example, sodium hydroxide. The modified PLAs can be de-volatized. The de-volatized PLAs can be blended with degradation-promoting agents. The degradation-promoting agents may include one or more organic acids, such as succinic acid, levulinic acid, lauric acid, and Lactide.

In an embodiment, a degradation-promoted biopolymer or a blended degradation-promoted biopolymer may be subjected to an environment that may contain water, a brine solution, an aqueous solution having other required chemicals for the fracking process, and/or oil. This can be particularly common in the oil and gas industry. For example, an engineered degradation-promoted polymer may be required to degrade about 35 percent to 98 percent in an aqueous solution at temperatures that may be 35° C. to 91° C. within 48 to 96 hours. Degradation may begin at first contact with environment. In some applications, the degradation time may extend to 30 days.

Embodiments herein have advantages for making, engineering, processing, and/or compounding of degradation-promoted polymers in accordance with their end-use application requirements and environmental conditions. The embodiments herein allow blending and compounding of degradable biopolymer(s) with degradation-promoting agent(s) that are designed to promote degradation of the resulting degradation-promoted polymers in accordance with end-use application requirements and environmental conditions. Furthermore, the embodiments herein allow promoting and controlling the degradation of degradation-promoted polymers utilizing biopolymer blends.

In an embodiment, a degradation-promoted polymer may be modified, for example, by blending and/or combining with other degradation-promoted polymer, fillers, or additives, for purposes of meeting processing needs and the physical and/or degradation requirements of the intended application or applicable environmental conditions. In an embodiment, the degradation-promoted polymer can be mixed with an input that may or may not be modified or compatibilized. In an embodiment, the filler is organic filler that may be dissolved in an aqueous environment. In an embodiment, the filler is a carbohydrate. In an embodiment, the filler is a starch.

Furthermore, for continuous process compounding a degradable bio-polymer with a degradation-promoting agent, the appropriate manner, sequence, steps and control of the compounding can be managed to achieve, among other things, an even distribution and disbursement of the degradation-promoting agent(s) without breaking down the degradation-promoting agent. An intimate contact of the degradation-promoting agent throughout the polymeric matrix of the degradable biopolymer may be achieved for better control and predictable rate of the degradation of the degradation promoted biopolymer for the specified application requirements and environmental conditions.

The terms “compound”, “blend”, “mix,” “combine,” “process” and “incorporate,” as well as their variants and synonyms, may be used interchangeably and as used herein are defined as a process, that may be continuous and that may utilize a twin screw compound extrusion machine, for homogeneously blending and mixing together of various inputs of at least one polymer with additives, such as degradation-promoting agents, that following the compounding of material the process may produce pellet, by strand pelletizing and flake or underwater pelletizing that may be further converted to powder form.

Applications for the degradation-promoted polymer include but not limited to such as for example a process for opening new oil wells, oil well work-overs, or oil well cleanout, in which each well may have a different temperature and environmental conditions and may require a different degradation rate of the polymer.

In an embodiment, a degradation-promoted polymer material may be engineered to be utilized in an environment having a temperature above 32° C. and an aqueous based environment, such as, for example, an oil well fracking zone.

In another embodiment, a degradation-promoted polymer may be engineered to degrade in a fracking process within the fracking zone of an oil well that said degradation to be at various rates from 35 percent to 98 percent over a 96-hour period based upon a well temperature that may be from approximately 49° C. to 91° C.

The embodiments described herein allow for the judicious utilization of various inputs for making and engineering degradation-promoted polymers so that the degradation-promoted polymers can degrade in accordance with target application(s) requirements and their given environmental conditions. The inputs can include, for example, biopolymers, degradation-promoting agents, catalysts, acids, fillers such as starch, sugars, and other additives that enhance the degradation of the biopolymer.

The embodiments described herein allow degradation rate and percentage of degradation of biopolymers (referred to herein also as “degradable biopolymers”) to be promoted, enhanced, and controlled. For example, many degradable biopolymers contain ester bonds and the degradable biopolymers degrade by molecular scission when these bonds are broken.

The embodiments described herein can provide a more environmentally friendly solution for the oil well fracking process and other aspects of the petroleum industry. Therefore, promoting and controlling the degradation of the biopolymers used in the fracking process, clean-out, or work-over of oil wells can be useful and beneficial.

It is to be understood that the embodiments may be combined or used separately, or that other embodiments may be used, and that design, implementation, and procedural changes may be made without departing from the spirit and scope of the methods described herein. The following detailed description provides examples and data resulting from experiments performed.

The experiments performed are illustrative of the engineered control that can be exerted on the degradation rates of degradation-promoted polymers. Slower degradation rates illustrated may be desirable based upon the application although the rates for fracking applications may differ from other applications. In addition, degradation rates for oil well applications may vary depending on the oil well depth, temperature and other factors. To this end, although the chosen inputs for the experiments are limited in scope, it is illustrated that by the judicious change of ratios and kinds of inputs of a degradation-promoted polymer the control over degradation is exemplified. All PLA's utilized in the experiments are commercial grades of NatureWorks®. The Lactide is produced by Corbian®. In an embodiment, the Lactide is a white semi-crystal solid and has a melting temperature in a range from 90° C. to 100° C. The Succinic Acid is produced by BioAmber® and the PHA was produced by Metabolix®. Ingeo™ Biopolymer 6362D is a PLA product from a NatureWorks LLC, and also referred to NatureWorks® 6362D or 6362D herein. The Ingeo™ Biopolymer 6362D has a specific gravity of about 1.24, a relative viscosity of about 2.5, a melt index of about 70-85 g/10 min at 210° C., a melt density of about 230° C., a glass transition temperature (Tg) of about 55-56° C., a crystalline melt temperature of about 125-135° C. Ingeo™ Biopolymer 4060D is also a PLA product from a NatureWorks LLC, and referred to NatureWorks® 4060D or 4060D herein. The Ingeo™ Biopolymer 4060D is amorphous material and has a specific gravity of about 1.24 and a relative viscosity of about 3.4.

All materials were tested for degradation as a function of time at different temperatures in an aqueous solution that may or may not contain 15 percent brine by the following procedures. The experiment is conducted in according to the following loss-in-weight test procedure.

Formulation samples are prepared by grinding pellets to a powder form and then aliquoted in sample jars covered with tap water. Brine may be added to the tap water to create a 15% brine solution. The number of sample jars for each formulation sample is dependent upon test time interval that is usually every 24 hours for 96-hour test and 72 hours for 30-day test. Each sample jar may contain, for example, about 10 grams or about 20 grams of the formulation sample for a test. For example, when testing degradation of a formulation sample at a given temperature between 120° F. and 190° F. and the test time interval is every 24 hours up to final at 96 hours, four jars would be required for testing degradation of this formulation sample and each jar can contain 20 grams of the formulation sample. A water bath such as a food warmer can be used for temperature control. Sample jars of each formulation sample are placed in the water bath at a desired test temperature. At each test time interval, a sample jar is removed from the water bath, and a filter paper is placed on a balance and a weight of the filter paper is measured. Contents of the sample jar removed from the water bath at the time interval are transferred on the filter paper. The sample jar is then rinsed with water that in turn is flushed through the filter paper to make sure that all solids content have been recovered from the jar. Thereafter, the filter paper with solids is place in an oven at a temperature of 250-300° F. for at least 24 hours until it is dried to obtain a dried filter paper. A weight of the obtained dried filter paper is measured by a balance. A loss-in-weight for this time interval is measured by subtracting the weight of the obtained dried filter paper with the weight of the filter paper itself.

To understand degradation or dissolving rate of a degradation-promoting agent utilized in the experiments for making the degradation-promoted polymer, experiments are conducted to evaluate the degradation or dissolving rate of the degradation-promoting agent as a function of time at different aqueous solution temperatures.

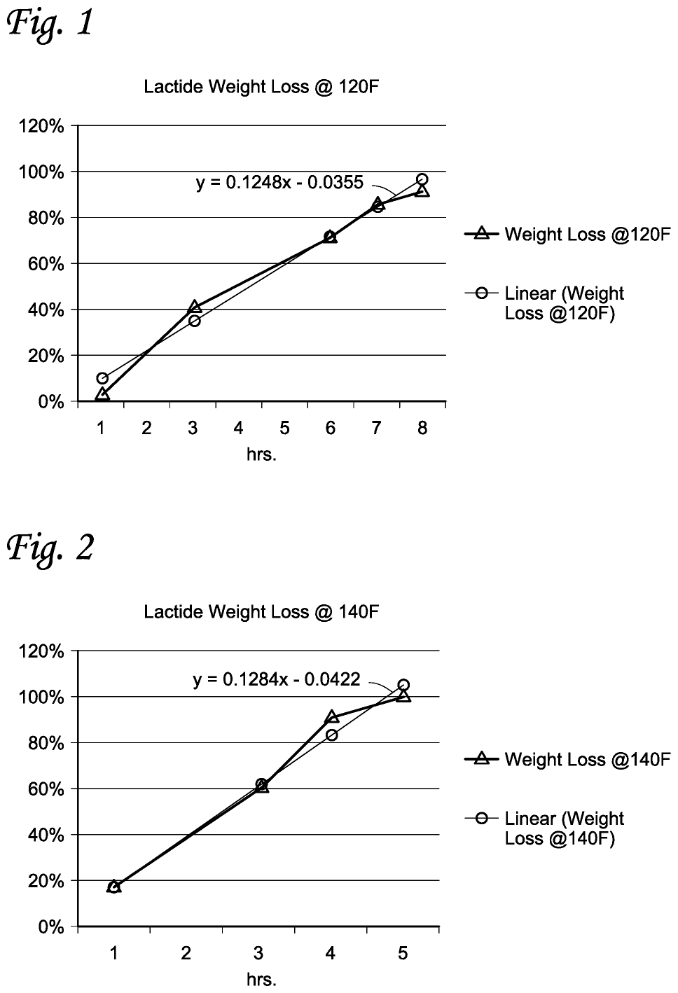

Referring to FIG. 1, FIG. 1 illustrates dissolution of Lactide at 120° F. as a function of time in an aqueous solution, according to an embodiment. As can be seen, the Lactide became dissolved or degraded at about 8 hours in the aqueous solution. The data is shown in Table 1.

Referring to FIG. 2, FIG. 2 illustrates dissolution of Lactide at 140° F. as a function of time in an aqueous solution, according to an embodiment. When the temperature is increased by 20 degrees relative the temperature in FIG. 1, the Lactide became dissolved in less than 5 hours in the aqueous solution. The data is shown in Table 1.

TABLE 1
dissolution of Lactide in a aqueous solution at different temperature
Lactide

| Time (hrs) | 1 | 2 | 3 | 4 | 5 | 6 | 7 | 8 |
|---|---|---|---|---|---|---|---|---|
| Weight | 17.03% | 38.71% | 59.61% | 91.20% | 100% | | | |
| Loss@140 F. | | | | | | | | |
| Weight | 2.69% | 20.03% | 40.28% | 49.61% | 60.93% | 71.29% | 85.13% | 91.09% |
| Loss@120 F. | | | | | | | | |

It is to be understood that succinic acid can also be dissolved over time at temperature 120° F. and 140° F. However, the dissolving rate can be slower than the Lactide.

Thus, each degradation-promoting agent in the degradation-promoted polymer may have a unique dissolving or degradation rate based upon the temperature.

To understand the effect of a degradation-promoting agent on controlling and promoting degradation of PLA in an aqueous solution, an experiment is conducted to evaluate the degradation of different types of PLA in an aqueous solution at different temperatures.

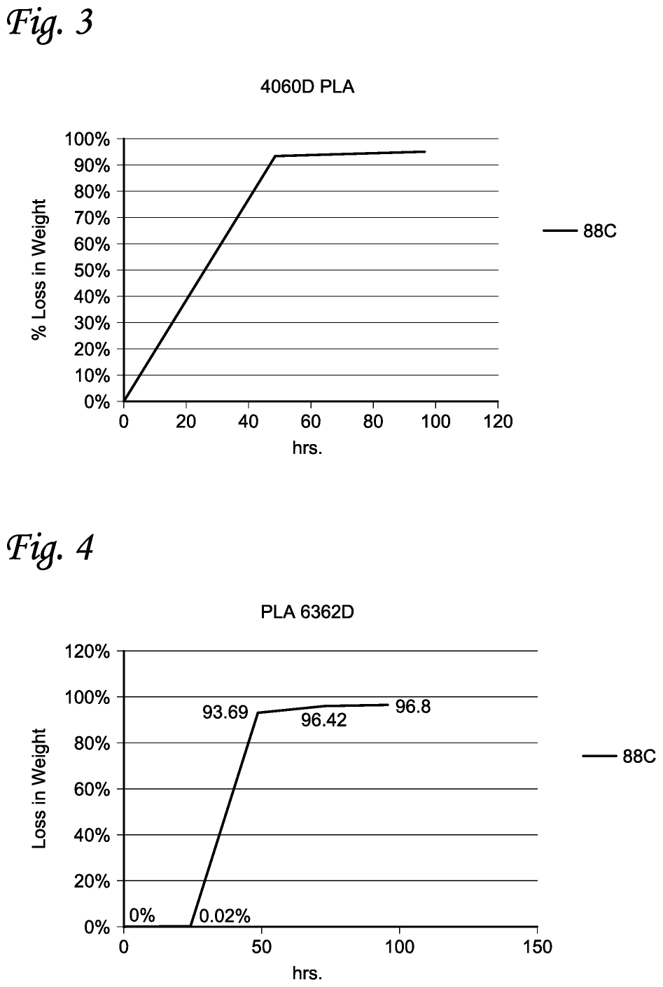

Referring to FIG. 3, FIG. 3 illustrates degradation of NatureWorks® 4060D PLA as a function of time in water solution at 88° C. and in the absence of a degradation-promoting agent, according to an embodiment. The test procedure for this embodiment used a 0 percent brine solution. As can be seen, about 47.7% of the NatureWorks® 4060D PLA is degraded or dissolved in the water solution at 24 hours. The data is shown in Table 2.

TABLE 2
degradation of the NatureWorks ® 4060D PLA in water solution at 88° C.
4060D PLA

| Time Hrs. | 0 | 24 | 48 | 72 | 96 |
|---|---|---|---|---|---|
| 88 C. | 0% | 47.70% | 93.60% | 93.98% | 94.82% |

Referring to FIG. 4, FIG. 4 illustrates degradation of NatureWorks® 6362D PLA as function of time in water solution at 88° C. and in the absence of a degradation-promoting agent, according to an embodiment. The test procedure for this embodiment used a 0 percent brine solution. As can be seen, about nearly 0% of the NatureWorks® 6362D PLA is degraded or dissolved in the water solution at 24 hours. The data is shown in Table 3.

TABLE 3
degradation of the NatureWorks ® 6362D PLA in water solution at 88° C.
PLA 6362D

| Time Hrs. | 0 | 24 | 48 | 72 | 96 |
|---|---|---|---|---|---|
| 88 C. | 0% | 0.02% | 93.69 | 96.42 | 96.8 |

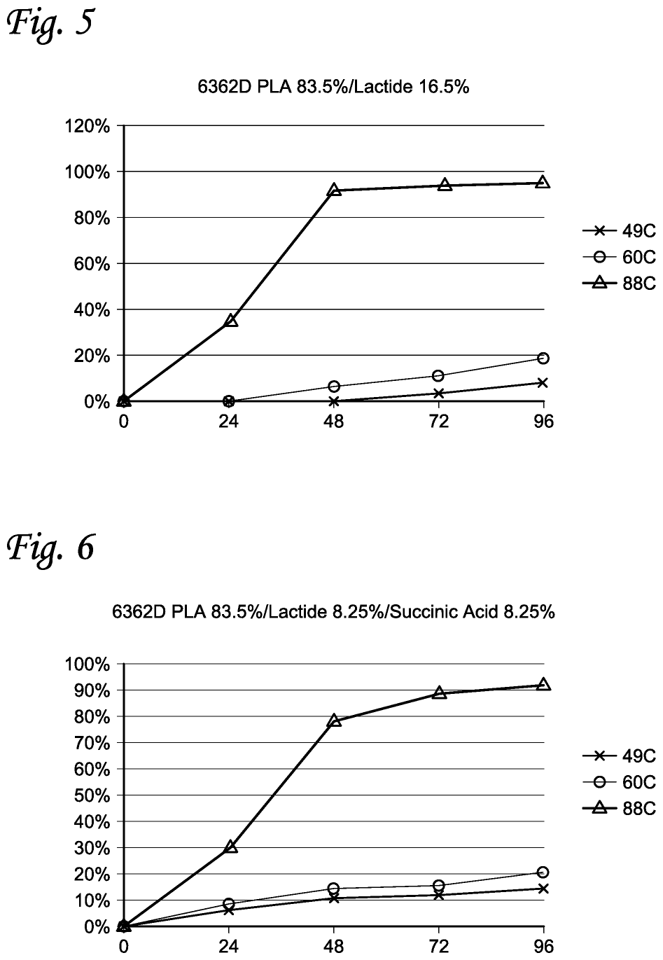

Referring to FIG. 5, FIG. 5 illustrates degradation of NatureWorks® 6362D PLA with addition of 16.5 percent Lactide as a degradation-promoting agent at temperatures of 49° C., 60° C., and 88° C., according to an embodiment. The Lactide is mixed with the NatureWorks® 6362D PLA by blending in a twin screw compounding extruder. The test procedure for this embodiment used a 15 percent brine solution. The data is shown in Table 4.

TABLE 4
PLA 83.5%/Lactide 16.5%

| Time hrs. | 24 | 48 | 72 | 96 |
|---|---|---|---|---|
| 49 C. | 0.00% | 0.00% | 3.53% | 8.38% |
| 60 C. | 0.00% | 6.21% | 11.53% | 19.03% |
| 88 C. | 34.61% | 92.63% | 94.63% | 95.29% |

Also investigated was the effect of different ratios of degradation-promoting agents Lactide and Succinic Acid as percentages by weight of the degradation-promoted polymer on controlling and promoting degradation of NatureWorks® 6362D PLA, which results are shown in FIGS. 6-10. The test procedure used a 15 percent brine solution.

Referring to FIG. 6, FIG. 6 illustrates degradation of a degradation-promoted polymer that has a composition of 83.5% NatureWorks® 6362D PLA, 8.25% Lactide, and 8.25% succinic acid at temperatures of 49° C., 60° C., and 88° C., according to an embodiment. The data is shown in Table 5.

TABLE 5
PLA 83.5%/Lactide 8.25%/Succinic Acid 8.25%

| Time hrs. | 24 | 48 | 72 | 96 |
|---|---|---|---|---|
| 49 C. | 5.73% | 10.51% | 11.95% | 14.15% |
| 60 C. | 8.16% | 13.87% | 15.37% | 20.20% |
| 88 C. | 29.81% | 77.95% | 88.68% | 92.00% |

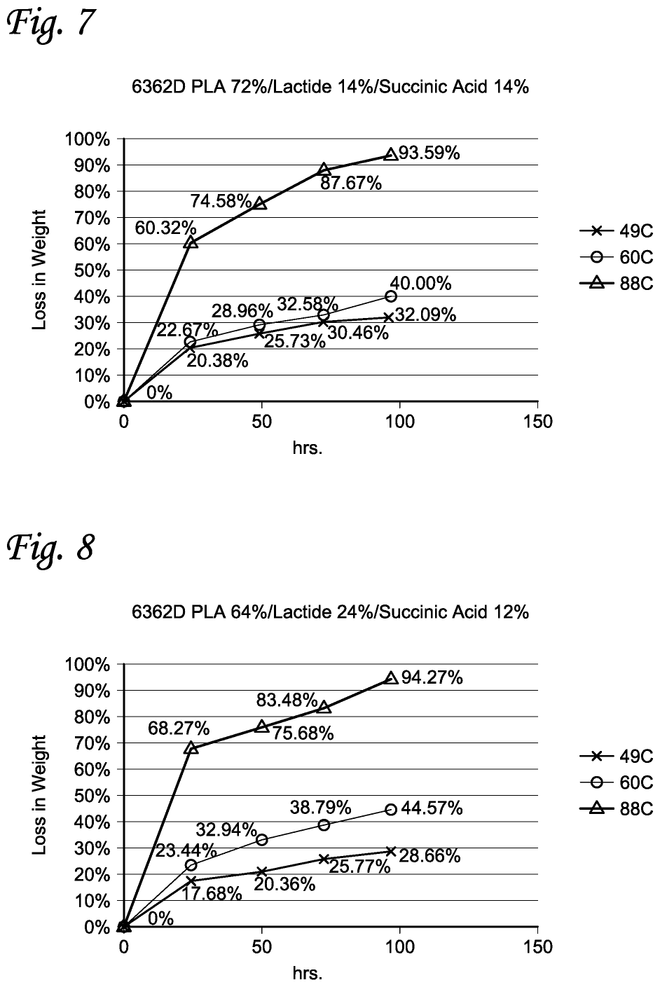

Referring to FIG. 7, FIG. 7 illustrates degradation of a degradation-promoted polymer that has a composition of 72% NatureWorks® 6362D PLA, 14% Lactide, and 14% succinic acid at temperatures of 49° C., 60° C., and 88° C., according to an embodiment. The data is shown in Table 6.

TABLE 6
6362D 72%/SA 14%/Lactide 14%

| Timer Hrs | 0 | 24 | 48 | 72 | 96 |
|---|---|---|---|---|---|
| 49 C. | 0.00% | 20.38% | 25.73% | 30.46% | 32.09% |
| 60 C. | 0.00% | 22.67% | 28.96% | 32.58% | 40.00% |
| 88 C. | 0.00% | 60.32% | 74.58% | 87.67% | 93.59% |

Referring to FIG. 8, FIG. 8 illustrates degradation of a degradation-promoted polymer that has a composition of 64% NatureWorks® 6362D PLA, 24% Lactide, and 12% succinic acid at temperatures of 49° C., 60° C., and 88° C., according to an embodiment. The data is shown in Table 7.

TABLE 7
6362D 64%/SA12%/Lactide 24%

| Timer Hrs | 0 | 24 | 48 | 72 | 96 |
|---|---|---|---|---|---|
| 49 C. | 0% | 17.68% | 20.36% | 25.77% | 28.66% |
| 60 C. | 0% | 23.44% | 32.94% | 38.79% | 44.57% |
| 88 C. | 0% | 68.27% | 75.68% | 83.48% | 94.27% |

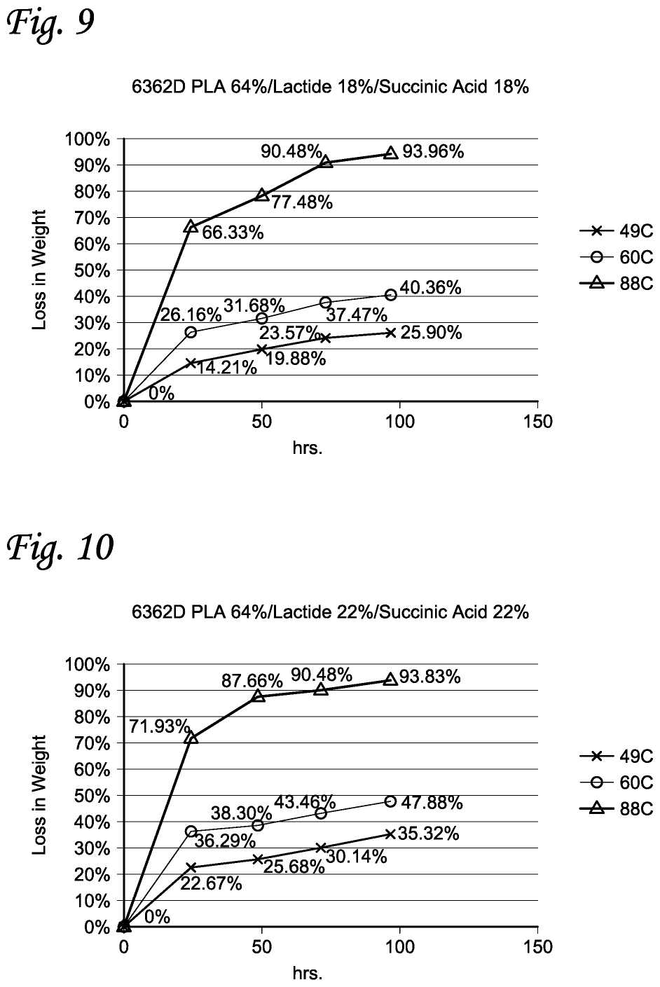

Referring to FIG. 9, FIG. 9 illustrates degradation of a degradation-promoted polymer that has a composition of 64% NatureWorks® 6362D PLA, 18% Lactide, and 18% succinic acid at temperatures of 49° C., 60° C., and 88° C., according to an embodiment. The data is shown in Table 8.

TABLE 8
6362D 54%/SA18%/Lactide 18%

| Timer Hrs | 0 | 24 | 48 | 72 | 96 |
|---|---|---|---|---|---|
| 49 C. | 0% | 14.21% | 19.88% | 23.57% | 25.90% |
| 60 C. | 0% | 26.16% | 31.68% | 37.47% | 40.36% |
| 88 C. | 0% | 66.33% | 77.48% | 90.48% | 93.96% |

Referring to FIG. 10, FIG. 10 illustrates degradation of a degradation-promoted polymer that has a composition of 66% NatureWorks® 6362D PLA, 22% Lactide, and 22% succinic acid at temperatures of 49° C., 60° C., and 88° C., according to an embodiment. The data is shown in Table 8.

TABLE 9
6362D 64%/SA 22%/Lactide 22%

| Timer Hrs | 0 | 24 | 48 | 72 | 96 |
|---|---|---|---|---|---|
| 49 C. | 0% | 22.67% | 25.68% | 30.14% | 35.32% |
| 60 C. | 0% | 36.29% | 38.30% | 43.46% | 47.88% |
| 88 C. | 0% | 71.93% | 87.66% | 90.48% | 93.83% |

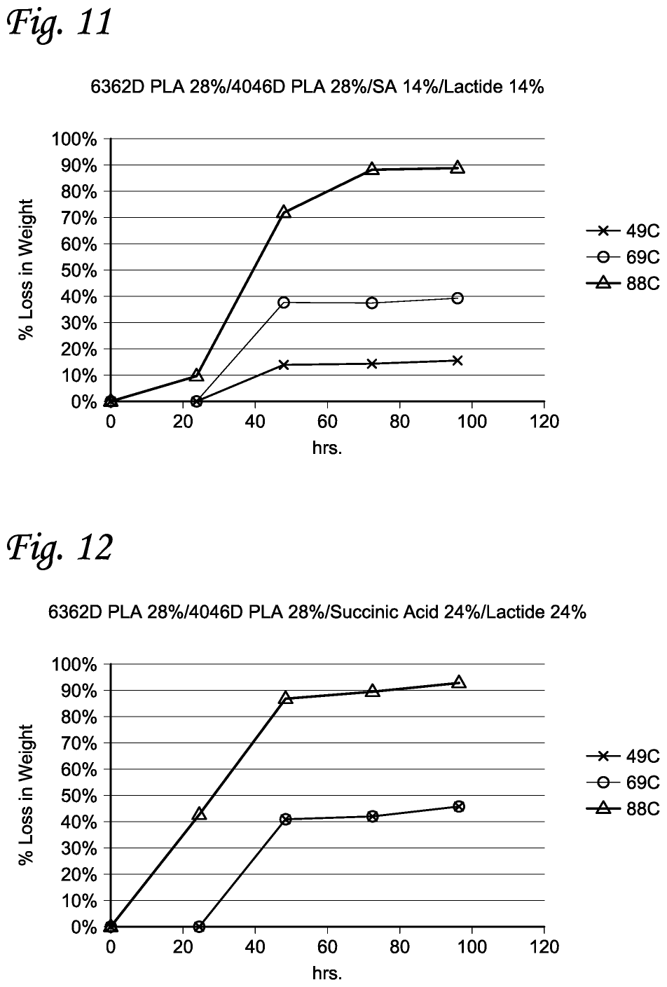

Referring to FIG. 11, FIG. 11 illustrates degradation of a degradation-promoted polymer that has a composition of 28% NatureWorks® 6362D PLA, 28% NatureWorks® 4046D PLA, 14% succinic acid at temperatures of 49° C., 69° C., and 88° C., according to an embodiment. The two NatureWorks® PLAs having different molecular weights and degrees of crystallinity are blended together with degradation-promoting agent before the test. The test procedure for this embodiment used a 0 percent brine solution. The data is shown in Table 10.

TABLE 10
6362D PLA 28%/4046D PLA 28%/SA 14%/Lactide 14%

| Timer Hrs | 24 | 48 | 72 | 96 |
|---|---|---|---|---|
| 49 C. | 0.00% | 0.1396 | 0.1416 | 0.1574 |
| 69 C. | 0% | 37.60% | 37.70% | 39.26% |
| 88 C. | 9.83% | 71.99% | 88.14% | 88.87% |

Referring to FIG. 12, FIG. 12 illustrates degradation of a degradation-promoted polymer that has a composition of 28% NatureWorks® 6362D PLA, 28% NatureWorks® 4046D PLA, 24% succinic acid, and 24% Lactide at temperatures of 49° C., 69° C., and 88° C., according to an embodiment. The test procedure for this embodiment used a 0 percent brine solution. The two NatureWorks® PLAs are blended together with degradation-promoting agents before the test. The data is shown in Table 11.

TABLE 11
6362D PLA 28%/4046D PLA 28%/Succinic
Acid 24%/Lactide 24%

| Timer Hrs | 24 | 48 | 72 | 96 |
|---|---|---|---|---|
| 49 C. | 0% | 40.59% | 42.32% | 45.90% |
| 69 C. | 0% | 40.59% | 42.32% | 45.90% |
| 88 C. | 42.37% | 86.93% | 89.62% | 92.90% |

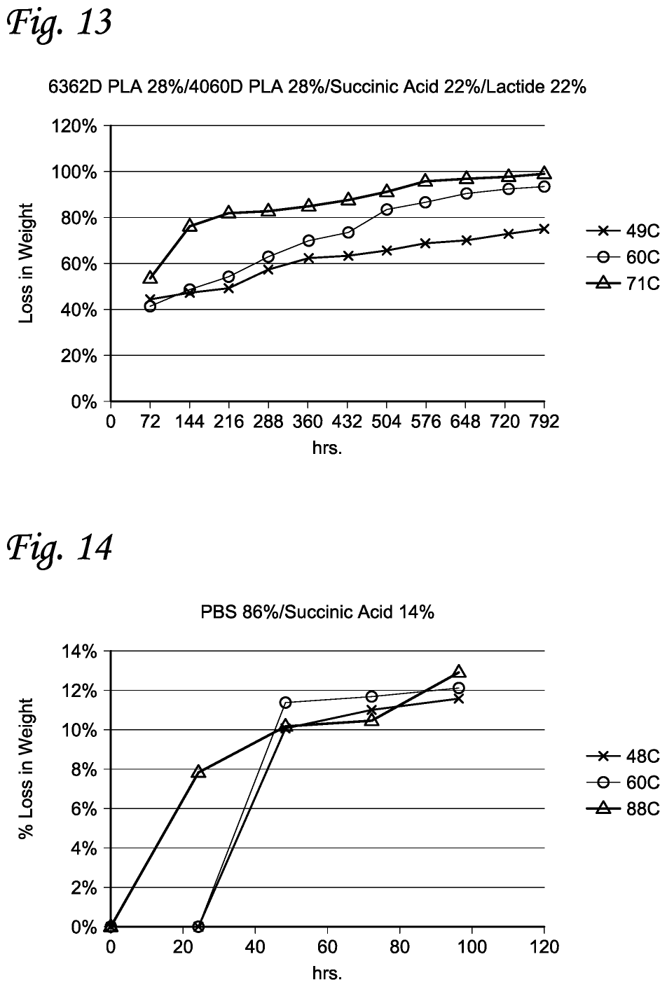

Referring to FIG. 13, FIG. 13 illustrates degradation of a degradation-promoted polymer that has a composition of 28% NatureWorks® 6362D PLA, 28% NatureWorks® 4046D PLA, 22% succinic acid, and 22% Lactide at temperatures of 49° C., 60° C., and 71° C. over about 30 day period, according to an embodiment. The two NatureWorks® PLAs are blended together with degradation-promoting agents before the test. The test procedure for this embodiment used a 0 percent brine solution. The data is shown in Table 12.

TABLE 12
6362D PLA 28%/4060D PLA 28%/Succinic Acid 22%/Lactide 22%

| Time Hrs. | 72 | 144 | 216 | 288 | 360 | 432 | 504 | 576 | 648 | 720 | 792 |
|---|---|---|---|---|---|---|---|---|---|---|---|
| 49 C. | 44.37% | 47.32% | 49.37% | 57.68% | 62.62% | 63.73% | 66.01% | 68.90% | 70.34% | 72.98% | 75.31% |
| 60 C. | 41.68% | 48.45% | 54.46% | 62.76% | 69.71% | 73.77% | 83.46% | 87.10% | 90.58% | 92.29% | 93.63% |
| 71 C. | 53.29% | 76.27% | 81.91% | 83.07% | 84.76% | 87.65% | 91.34% | 96.03% | 97.06% | 97.70% | 99.23% |

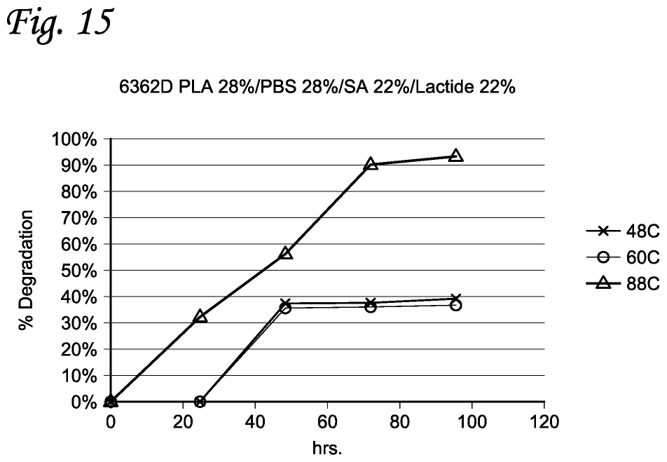

PBS is a degradable biopolymer. Effect of degradation-promoting agent on promoting and controlling degradation of PBS was also studied, which results are shown in FIGS. 14 and 15. Referring to FIG. 14, FIG. 14 illustrates degradation of a degradation-promoted polymer that has a composition of 86% PBS and 14% succinic acid at temperatures of 48° C., 60° C., and 88° C., according to an embodiment. The data is shown in Table 13. Components of the composition are blended together before the test. The test procedure used a 0 percent brine solution.

TABLE 13
PBS 86%/Succinic Acid 14%

| Timer Hrs | 24 | 48.00 | 72 | 96 |
|---|---|---|---|---|
| 48 C. | | 11.37% | 11.71% | 12.10% |
| 60 C. | | 10.04% | 10.98% | 11.59% |
| 88 C. | 7.78% | 10.16% | 10.47% | 12.91% |

Referring to FIG. 15, FIG. 15 illustrates degradation of a degradation-promoted polymer that has a composition of 28% NatureWorks® 6362D PLA, 86% PBS, and 14% succinic acid at temperatures of 48° C., 60° C., and 88° C. The data is shown in Table 14. The test procedure used a 0 percent brine solution.

TABLE 14
PLA 28%/PBS 28%/SA 22%/Lactide 22%

| Timer Hrs | 24 | 48 | 72 | 96 |
|---|---|---|---|---|
| 48 C. | | 37.46% | 37.69% | 39.33% |
| 60 C. | | 35.55% | 36.45% | 37.14% |
| 88 C. | 31.70% | 56.19% | 90.13% | 93.69% |

In some embodiments, a degradation-promoted polymer has a composition of PLA, PHA and degradation-promoting agents. In an embodiment, the PHA is Metabolix® PHA. In an embodiment, the PLA is NatureWorks® PLA. The degradation-promoting agents can also promote and control degradation of PHA that is mixed with PLA.

It is illustrated that by varying the ratios of the degradation-promoting agents that the degradation rates vary from formulation to formulation at given temperatures. Different solutions are used in a well. The industry commonly used straight well water or a brine solution. Also illustrated is the control over the degradation that can be obtained dependent upon ratios of inputs for the temperatures tested as a function of time.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

### Aspects:

It is noted that any of aspects 1-11 can be combined with any of aspects 12-25.
Aspect 1. A composition of a degradation-promoted polymer, comprising
   a polymer,
   an organic acid,
   a Lactide.
Aspect 2. The composition of aspect 1, where in the organic acid is succinic acid.
Aspect 3. The composition of aspect 1, wherein the organic acid is an acid having a pH value lower than 3.0 at 100 mM concentration and 23° C.
Aspect 4. The composition of aspect 1, wherein the organic acid is an acid having a pH value lower than 2.5 at 100 mM concentration and 23° C.
Aspect 5. The composition of aspect 1, wherein the organic acid is an acid having a pH value lower than 2.0 at 100 mM concentration and 23° C.
Aspect 6. The composition of aspects 1-5, wherein the polymer includes PHA or PLA.
Aspect 7. The composition of aspects 1-7, wherein the polymer has a composition including two or more different degradable polymers.
Aspect 8. The composition of aspect 7, wherein the two or more polymer have different glass transition temperature (Tg).
Aspect 9. The composition of aspects 1-8, the degradation-promoted polymer has a Tg greater than 27° C.
Aspect 10. The composition of aspects 1-8, the degradation-promoted polymer has a Tg greater than 40° C.
Aspect 11. The composition of aspects 7 and 8, the two or more polymers are different PLA.
Aspect 12. A method for making a degradation-promoted polymer, comprising:
   mixing a polymer with a degradation promoting agent to produce a degradation-promoted polymer,
   wherein the degradation-promoting agent includes an organic acid and a Lactide.
Aspect 13. The method of aspect 12, further comprising blending a compatibilized filler with the degradation-promoted polymer to produce a degradation-promoted polymer composite.
Aspect 14. The method of aspect 13, further comprising extruding the degradation-promoted polymer composite to form a predetermined shape.
Aspect 15. The method of aspects 13 and 14, further comprising venting and evacuating the degradation-promoted polymer composite to remove residual water.
Aspect 16. The method of aspects 12-15, further comprising blending the degradation-promoted polymer composite with a second filler to produce a degradation-promoted composite polymer.
Aspect 17. The method of aspects 12-16, wherein the mixing a polymer with a degradation-promoting agent includes blending two or more polymers.
Aspect 18. The method of aspect 17, wherein the two or more polymers are different type of PLA having different Tg.
Aspect 19. The method of aspects 17 and 18, wherein the two or more polymers are in crystalline, semi-crystallize, or amorphous forms.
Aspect 20. The method of aspects 12-20, wherein the mixing a polymer with a degradation-promoting agent includes blending a PHA or PBS.
Aspect 21. The method of aspects 12, wherein the mixing a polymer with a degradation-promoting agent including compounding the polymer with a succinic acid.
Aspect 22. The method of aspects 12-21, wherein the organic acid is an acid having a pH value 5.0-1.0 at 100 mM concentration and 23° C. Aspect 23. The method of aspects 12-21, wherein the organic acid has a pH value 3.0-1.0 at 100 mM concentration and 23° C.
Aspect 24. The method of aspects 12-21, wherein the organic acid is an acid having pH value a pH value 2.0-1.0 at 100 mM concentration and 23° C.
Aspect 25. The method of aspect 12, further comprising blending a filler with the degradation-promoted polymer to produce a degradation-promoted polymer composite and the filler is not compatibilized with the degradation-promoted polymer.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What claimed is:

1. A composition of a degradation-promoted polymer, comprising:
a polymer,
an organic acid,
a Lactide.

2. The composition of claim 1, wherein the organic acid includes succinic acid, levulinic acid, or lauric acid, or a combination thereof.

3. The composition of claim 1, wherein the organic acid includes succinic acid.

4. The composition of claim 1, wherein the organic acid includes levulinic acid..

5. The composition of claim 1, wherein the organic acid includes lauric acid.

6. The composition of claim 1, wherein the organic acid includes succinic acid, levulinic acid, and lauric acid

7. The composition of claim 1, wherein the polymer includes PHA including PLA and Polybutylene succinate.

8. The composition of claim 1, wherein the polymer has a composition including two or more different degradable polymers.

9. The composition of claim 8, the two or more different degradable polymers are different PLA.

10. A method for making a degradation-promoted polymer, comprising:
mixing a polymer with a degradation-promoting agent to produce a degradation-promoted polymer,
wherein the degradation-promoting agent includes an organic acid and a Lactide.

11. The method of claim 10, further comprising blending a filler with the degradation-promoted polymer to produce a degradation-promoted polymer composite.

12. The method of claim 11, further comprising extruding the degradation-promoted polymer composite to form a predetermined shape.

13. The method of claim 11, further comprising venting and evacuating the degradation-promoted polymer composite to remove residual water.

14. The method of claim 11, further comprising blending the degradation-promoted polymer composite with a second filler to produce a degradation-promoted composite polymer.

15. The method of claim 10, wherein the step of mixing the polymer with the degradation-promoting agent includes blending two or more polymers.

16. The method of claim 15, wherein the two or more polymers are different types of PLA having different Tg.

17. The method of claim 10, wherein the step of mixing the polymer with the degradation-promoting agent includes blending a PHA.

18. The method of claim 10, wherein the step of mixing the polymer with the degradation-promoting agent includes compounding the polymer with a succinic acid.

19. The method of claim 10, wherein the organic acid includes succinic acid, levulinic acid, or lauric acid, or a combination thereof.

20. The method of claim 10, wherein the organic acid includes succinic acid, levulinic acid, and lauric acid.
